(19) United States
(12) Patent Application Publication
(10) Pub. No.: US 2008/0173355 A1
(43) Pub. Date: Jul. 24, 2008

(54) EMERGENCY OXYGEN SUPPLY SYSTEM

(75) Inventors: Rudiger MECKES, Berkenthin (DE); Rudiger CONRAD, Stockelsdorf (DE)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: DRAGER AEROSPACE GMBH, Lubeck (DE)

(21) Appl. No.: 12/016,296

(22) Filed: Jan. 18, 2008

(30) Foreign Application Priority Data
Jan. 18, 2007 (DE) 10 2007 003 602.9

(51) Int. Cl. G05D 11/00

(52) U.S. Cl. 137/109

(57) ABSTRACT

An emergency oxygen supply system, particularly in an aircraft, has an oxygen supply conduit with a conduit junction. This conduit junction is formed by a valve, which forms a flow path from an oxygen inlet to two oxygen outlets, wherein the valve is designed in a manner such that one of the oxygen outlets may be selectively closed.

### BACKGROUND OF THE INVENTION

The invention relates to an emergency oxygen supply system, particularly for use in aircraft, having an oxygen supply conduit.

Devices for the emergency supply of oxygen in aircraft are known, with which the oxygen masks of passengers and crew are conductingly connected to an oxygen source via a conduit network installed in the aircraft. Here, the oxygen conduits are also installed in regions, in which one may not completely rule out the possibility of damage due to broken-off turbine blades, and thus of a leakage of the oxygen conduit.

In order to ensure the emergency supply of oxygen even in such a case, it is known to not only provide one conduit in these regions, but two conduit lines led in parallel, so that the second conduit line is still redundantly available for the supply of oxygen should one conduit line be damaged. Thereby, however, it is necessary to shut off the damaged conduit line. While the shut-off means may be formed at the downstream ends of the conduit lines by way of return valves, which prevent a through-flow of the conduit lines opposite to their correct through-flow direction, electrically actuated shut-off means are provided at the onflow ends of the conduit lines. These are activated by differential pressure switches, which are arranged in the end regions of the conduit lines, said end regions being on the downstream side. With these known emergency oxygen supply systems, however, the installation of the shut-off means as well as of the differential pressure switches, and the installation of the electrical cables which are required for this, entails a significant amount of effort with regard to the assembly. Moreover, there is also the danger of the electricity supply leads and signal leads of the differential pressure sensor likewise being damaged by way of flying parts of turbine blades, which in the most unfavorable case may lead to the failure of the emergency supply of oxygen.

### BRIEF SUMMARY OF THE INVENTION

Against this background, it is the object of the invention to provide an oxygen emergency supply system which ensures a safe emergency supply of oxygen to the aircraft occupants, and may be realized in an inexpensive manner without much effort with regard to assembly.

The emergency oxygen supply system according to the invention comprises an oxygen supply conduit with a conduit junction, at which the oxygen supply conduit divides into two parallel conduit lines. These two conduit lines are arranged within the aircraft at a large distance, so that there is essentially no danger of a simultaneous damage of both conduits due to broken-off turbine blades. According to the invention, the conduit junction is formed by a valve, which forms a flow path from an oxygen inlet to two oxygen outlets, thus to the parallel conduit lines. Thereby, the valve is designed in a manner such that one of the oxygen outlets may be selectively closed.

The oxygen supply conduit coming from an oxygen source is connected to the oxygen inlet of the valve. The flow path, in the valve, diverges into two flow channels, which run out at the oxygen outlets of the valve. Two conduits depart from the oxygen outlets of the valve, and are installed in the endangered region of the aircraft, in order then to be led together outside this region again into one oxygen supply conduit. The valve is designed such that it may be switched in a manner such that it creates a flow connection from the oxygen inlet to the two oxygen outlets in a first switch position. Apart from this, the valve may be switched into two further switch positions, in which either the flow path from the oxygen inlet to a first oxygen outlet is blocked, or the flow path to a second oxygen outlet is blocked.

This design permits the redundant feed of two oxygen supply conduits led in parallel, in the endangered region of the aircraft described above, wherein however, only one pneumatic component is necessary in order, as the case may be, to shut-off a damaged oxygen supply conduit and thus prevent an undesired loss of oxygen, in contrast to that which has been known until now.

In a preferred design, the valve may be switched automatically in dependence on the oxygen pressure prevailing at the oxygen outlets. Thus, one may provide means with which the oxygen pressure may be detected at the exit side of the valve, i.e. in the two conduit lines in the endangered region. Apart from this, useful control means are provided, which in the case of a pressure drop at one of the oxygen outlets, which is caused by a leakage at the conduit line connected there, activate the valve in a manner such that the oxygen outlet concerned is closed.

Advantageously, the valve comprises a differential pressure sensor, which is designed in a manner such that it detects the oxygen pressure at the measurement locations which are provided in the region of the oxygen outlets. It is therefore possible with the differential pressure sensor, to detect and compare the oxygen pressure at both oxygen outlets of the valve. Given a pressure difference, i.e. given different pressures at the two oxygen outlets, which is an indication of damage to one of the two oxygen conduits departing from the oxygen outlets, the valve may be set by way of a suitably designed control, such that the oxygen outlet of the valve from which the damaged oxygen conduit departs, is closed.

Orifice plates are preferably arranged at the oxygen outlets on the onflow side of the measurement locations. That is, reductions in the cross section are provided at the exit of the conduit junction, which, given a through-flow, lead to a reduction of the oxygen pressure downstream of the orifice plates. The mass flows flowing through the orifice plates may be compared by way of determining the difference of the oxygen pressure behind the orifice plates, and a leakage of the oxygen conduits connected to the oxygen outlets may be ascertained in this manner.

The constructional shape of the valve forming the conduit junction of the emergency oxygen supply system according to the invention is basically infinite, as long as the valve has an inlet which is flow-connected to outlets, wherein the valve, apart from a position in which the inlet of the valve is flow-connected to both outlets, may be switched into two further positions, in which in each case one of the two outlets is closed. Thus, the valve may for example be designed as a slide valve. The valve however particularly preferably has a rotatable, preferably spherical valve body, which comprises a flow channel communicating with the oxygen inlet and the oxygen outlets of the valve.

With this design, three flow channels are provided on the housing of the valve, which depart from the oxygen inlet as well as the two oxygen outlets, and run out in a valve chamber formed in the housing. The shape of the valve chamber is complementary to the shape of the valve body and, given a spherical valve body, is designed for example in the manner of a hollow ball.

The valve body preferably comprises a first flow channel which connects two openings, formed on the outer periphery of the valve body, to one another. Apart from this, a second flow channel is provided on the valve body, which departs from its outer side and runs out in the first flow channel. The first and the second flow channel formed on the valve body are usefully aligned in a manner such that in a first switch position, the first flow channel of the valve body may be brought to meet with the flow channels of the valve housing which run out at the oxygen outlets, so that the housing of the valve and the valve body form a common flow channel through the valve, wherein simultaneously the second flow channel formed on the valve body, together with the flow channel on the valve housing and departing from the oxygen inlet, likewise form a common flow channel, which then runs out in the flow channel of the valve which connects the oxygen outlets.

Moreover, the flow channels on the valve body are arranged in a manner such that the valve body may be rotated into two further switch positions, in which a flow connection from the oxygen inlet to only one oxygen outlet is created, while the flow connection to the respective other oxygen outlet of the valve is closed.

The valve body is advantageously coupled in movement to a drive motor, preferably to an electrically operated drive motor, for actuating or switching the valve. Thereby, a drive shaft of the drive motor may be actively connected directly to the valve body, but a movement coupling of the drive motor to the valve body via a gear, preferably via a step-down gear, is provided.

Usefully, the drive motor may be activated by the differential pressure sensor. Accordingly, a signal produced by the differential pressure sensor, given a pressure difference at the two oxygen outlets, is used as an activation signal for the drive motor. In order to be able to test the functional reliability of the valve in the installed condition, preferably further control means are provided, with which a sequential activation of each switch condition of the valve is possible by way of an external control command. Preferably, one may ascertain as to whether the valve has reached the correct switch position in each case, by way of contacts or end switches provided on the valve.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic sectional representation of a valve of the emergency oxygen supply system according to one embodiment of the invention, which forms a conduit junction.

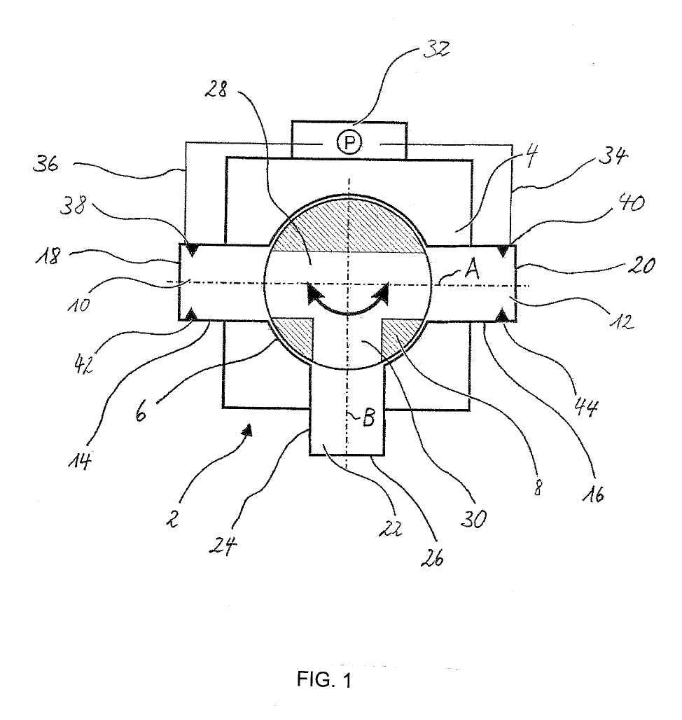

### DETAILED DESCRIPTION OF THE INVENTION

The valve 2 shown in the Figure, comprises a housing 4, in which a hollow, spherical valve chamber 6 is centrally formed. A spherically designed valve body 8 is mounted with low play and in a rotatably movable manner in the valve chamber 6.

Two flow channels 10 and 12 extend through the housing 4 of the valve 2, which on the one hand run out in the valve chamber 6, and on the other hand in two connection stubs 14 and 16 arranged on the outer side of the housing 4. Thereby, the flow channel 10 on the connection stub 14 forms a first oxygen outlet 18, and the flow channel 12 on the connection stub 16 forms a second oxygen outlet 20. The flow channels 10 and 12 are aligned such that they have a common longitudinal axis A, wherein the longitudinal axis A runs through the middle point of the valve chamber 6.

Moreover, a further flow channel 22 is provided on the housing 4, which on the one hand likewise runs out in the valve chamber 6, and on the other hand in a further connection stub 24 arranged on the outer side of the housing 4. The connection stub 24 forms an oxygen inlet 26. The flow channel 22 has a longitudinal axis B, and is arranged such that the longitudinal axis A of the flow channels 10 and 12, as well as the longitudinal axis B of the flow channel 22 lie in a common plane, wherein the longitudinal axis A is aligned normally to the longitudinal axis B.

The valve body 8 is broken through by a bore which runs through the center point of the ball and which forms a flow channel 28 in the valve body 8. Furthermore, a further flow channel 30 is provided on the valve body 8, and is aligned normally to the flow channel 28 and runs out in this in the region of the ball center point of the valve body 8. Together, the flow channels 28 and 30 form a T-shaped flow junction.

The valve body 8 which is rotatably mounted in the valve chamber 6 may be rotated into a position in which the flow channel 28 of the valve body 8 is flush with the flow channels 10 and 12 formed on the housing 4, and simultaneously the flow channel 30 of the valve body 8 is flush with the flow channel 22 of the housing 4. In this manner, a flow connection from the oxygen inlet 26 of the connection stub 24 to the oxygen outlets 18 and 20 formed on the connection stubs 14 and 16 is formed.

Moreover, the valve body 8 may be rotated into a position, in which the flow channel 28 of the valve body is flush with the flow channel 22 of the housing 4, as well as the flow channel 30 of the valve body being flush with the flow channel 12 of the housing 4. In this position, the flow channel 10 of the housing 4 is closed by the valve body 8, so that only one flow connection from the oxygen inlet 26 to the oxygen outlet 20 exists. Finally, yet a further position of the valve body is provided, in which the flow channel 22 of the housing, the flow channel 28, as well as the flow channel 30 of the valve body 8 together with the flow channel 10 of the housing 4, form a flow path from the oxygen inlet 26 to the oxygen outlet 18, wherein the flow channel 12 to the oxygen outlet 20 is closed by the valve body 8.

The rotation of the valve body 8 into the above described switch positions, is effected by way of an electrically actuatable drive motor which is not represented in the drawing figure, and which is arranged in the housing 4 of the valve 2. Here, the coupling of the movement of the drive motor to the valve body 8 is effected by way of a step-down gear which is likewise not represented.

The activation of the drive motor is effected via a differential pressure sensor 32 arranged on the outer side of the housing 4. Measurement locations 38 and 40 are conductively connected to the differential pressure sensor 32 via conduits 34 and 36. Thereby, one measurement location 38 is arranged in the flow channel 10 between the oxygen outlet 18 and an orifice plate 42 arranged in the vicinity of the oxygen outlet 18, and a further measurement location 40 is provided directly downstream of an orifice plate 44 which is provided in the flow channel 12 in the vicinity of the oxygen outlet 20.

An oxygen supply conduit which is not shown and which comes from an oxygen source which is likewise not shown in the figure, is connected to the connection stub 24 forming the oxygen inlet 26, in the installed condition of the valve 2 in the emergency oxygen supply system according to the invention. Conduit lines of the oxygen supply conduit which are installed in an aircraft in a region endangered by broken-away turbine blades, and which are not represented in the figure, are connected to the two connection stubs 14 and 16. In the case of decompression, oxygen is led from the oxygen source via the valve 2 and the oxygen supply conduits arranged thereon on the entry and exit side, to the oxygen masks of the aircraft occupants.

The oxygen pressure or mass flow of the oxygen which flows through, is detected at the oxygen outlets 18 and 20 at the measurement locations 38 and 40. If one of the conduit lines of the oxygen supply conduit which are connected to the connection stub 14 or 16 should become damaged, so that oxygen may exit into the surroundings at this conduit line, then this damage is expressed at the oxygen outlet 18 or 20 of the related connection stub 14 or 16 respectively, in the form of a pressure drop and in the form of an increased mass flow which this entails.

A pressure difference arising given a leakage of a conduit line is determined by way of the comparison of the pressure values at the two oxygen outlets 18 and 20, and this pressure difference is converted into a control signal, with which the drive motor is activated to actuate the valve body 8 of the valve 2, in a manner such that the flow channel of the valve 2, which leads to the connection stub 14 or 16 to which the damaged conduit line is connected, is closed, so that the oxygen 15 led to the aircraft occupants only via the intact conduit line.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An emergency oxygen supply system in an aircraft, comprising an oxygen supply conduit, having a conduit junction, wherein the conduit junction is formed by a valve (2) which forms a flow path from an oxygen inlet (26) to two oxygen outlets (18, 20), and wherein the valve (2) is designed in a manner such that one of the oxygen outlets (18, 20) may be selectively closed.

2. The An emergency oxygen supply system according to claim 1, wherein the valve (2) may be automatically switched in dependence on an oxygen pressure prevailing at the oxygen outlets (18, 20).

3. The emergency oxygen supply system according to claim 1, wherein the valve (2) comprises a differential pressure sensor (32), which is designed in a manner such that it detects an oxygen pressure at measurement locations (38, 40) provided in a region of the oxygen outlets (18, 20).

4. The emergency oxygen supply system according to claim 3, wherein an orifice plate (42, 44) is arranged at each of the oxygen outlets (18, 20) at an onflow side of the measurement locations (38, 40).

5. The emergency oxygen supply system according to claim 1, wherein the valve (2) comprises a rotatable valve body (8), which comprises a flow channel (28, 30) communicating with the oxygen inlet (26) and the oxygen outlets (18, 20) of the valve (2).

6. The emergency oxygen supply system according to claim 5, wherein the valve body (8) is coupled in movement to a drive motor.

7. The emergency oxygen supply system according to claim 6, wherein the drive motor is activated by a differential pressure sensor (32).

8. The emergency oxygen supply system according to claim 5, wherein the valve body (8) is spherical.
